(19) United States
(12) Patent Application Publication
(10) Pub. No.: US 2002/0009219 A1
(43) Pub. Date: Jan. 24, 2002

(54) Wafer pattern observation method and device

(76) Inventor: Ryoichi Matsuoka, Chiba-shi (JP)

Correspondence Address: ADAMS & WILKS, 31st Floor, 50 Broadway, New York, NY, 10004, US

(21) Appl. No.: 09/903,600

(22) Filed: Jul. 12, 2001

(30) Foreign Application Priority Data
Jul. 14, 2000 (JP) 2000-214845

(51) Int. Cl. G06K 9/00

(52) U.S. Cl. 382/141; 382/151

(57) ABSTRACT

An observation position designation section 8 determines a plurality of control points for a wafer pattern formed on a wafer 4 based on CAD data, and generates observation coordinate data D according to the plurality of determined control points, causes a navigation unit 5 to move in accordance with the observation coordinate data D, and automatically and sequentially positions a pattern observation device body 3 on the plurality of observation points for observation.

### BACKGROUND OF THE INVENTION

1. Field of the Invention

The present invention relates to a wafer pattern observation method and device that determines observation positions using CAD data.

2. Description of the Prior Art

In various semiconductor manufacturing processes, a wafer pattern observation device is used when the need arises to check whether or not a wafer pattern (hereinafter simply called pattern) on a wafer has been formed as planned, or to check whether or not the formed pattern is defective. A wafer pattern observation device used for this type of purpose magnifies an observational subject pattern portion, within an area from a few to a few tens of μm square in a pattern formed on the wafer, to a high magnification factor and performs observation, which means that the observational field of view of the wafer pattern observation device must be positioned with high precision at a desired observation position on the wafer.

In the related art, observation points on the wafer are determined according to the intuition and experience of the user, the observational field of view of the wafer pattern observation device is manually aligned and necessary pattern observation is performed sequentially one at a time for the observation points determined in this manner.

Accordingly, the conventional wafer pattern observation method involves the following problems.

(1) In checking that the pattern formed on the wafer is adequate, it is necessary to set a considerable number of control points, but it is impossible for an operator to perform setting of the necessary control points across a number of places relying on their intuition and experience, and as a result it is not possible to realize reliable pattern observation.

(2) Since the determination of the observation positions relies on manual operation, it takes time to determine the observation positions, which is bad from the point of view of working efficiency. In particular, there is a noticeable lowering of working efficiency when observing multiple products.

(3) Since the wafer pattern observation device is operated manually to perform necessary pattern observation, the pattern observation takes time, which is not efficient.

### SUMMARY OF THE INVENTION

An object of the present invention is to provide a wafer pattern observation method and device that can solve the problems described above that exist in the related art.

In order to solve the above described problems, according to the present invention there is provided a wafer observation method for enlarging and observing, with a pattern observation device, and a plurality of wafer pattern control points formed on a wafer based on CAD data, in which the plurality of control points are determined by analysis of the CAD data, a set of observation coordination data are acquired in accordance with the determined plurality of control points, the CAD data are referenced to carry out positional navigation in accordance with the set of observation coordinate data, and the determined plurality of control points of the wafer pattern are sequentially observed.

Analysis of CAD data for determination of the plurality of control points can be carried out using lithography simulation, device simulation, process simulation, etching simulation, or a CAD pattern density analysis method. In this way, by determining control points based on analysis of CAD data, appropriate control points can be acquired in a short time, and it is possible to automatically and sequentially observe using a navigation method to position the determined control points.

According to the present invention, there is also provided a wafer pattern observation device for enlarging and observing, with a pattern observation device, a plurality of wafer pattern control points formed on a wafer based on CAD data, comprising a pattern observation device body, determination means for analyzing the CAD data and determining a plurality of control points, means for acquiring a set of observational coordinate data based on the plurality of control points determined by the determination means, and a CAD navigation device for sequentially and automatically performing observational positioning for the pattern observation using the pattern observation device body according to the set of observational coordinate data and the CAD data.

In this case also, analysis of CAD data for determination of the plurality of control points can be carried out using lithography simulation, device simulation, process simulation, etching simulation, or a CAD pattern density analysis method.

The positional navigation for positioning the field of view of the pattern observation device on the required control points can be realized as a navigation method that performs observational positioning of the pattern observation device to a low magnification factor so that observation centers of the control points are placed in an observation field of view to acquire wafer pattern low magnification factor pattern image data, calculates an offset amount between the observation centers and centers of the observation field of view from the low magnification factor pattern image data and CAD graphics data corresponding to the low magnification factor pattern image data, and performs relative positional control of the wafer based on this offset amount data so that the centers of observation are aligned with the centers of the observation field of view.

### BRIEF DESCRIPTION OF THE DRAWINGS

FIG. 1 is a system schematic diagram showing one example of an embodiment of a wafer pattern observation system of the present invention.

FIG. 2 is a block diagram showing an example of the structure of the observation point designation section shown in FIG. 1.

FIG. 3 is a flowchart for explaining operation of the navigation unit shown in FIG. 1.

FIG. 4 is a block diagram for explaining one example of a device structure of the navigation unit shown in FIG. 1.

### DETAILED DISCRIPTION OF THE PREFERRED EMBODIMENTS

One example of an embodiment of the present invention will be described in more detail in the following with reference to the drawings.

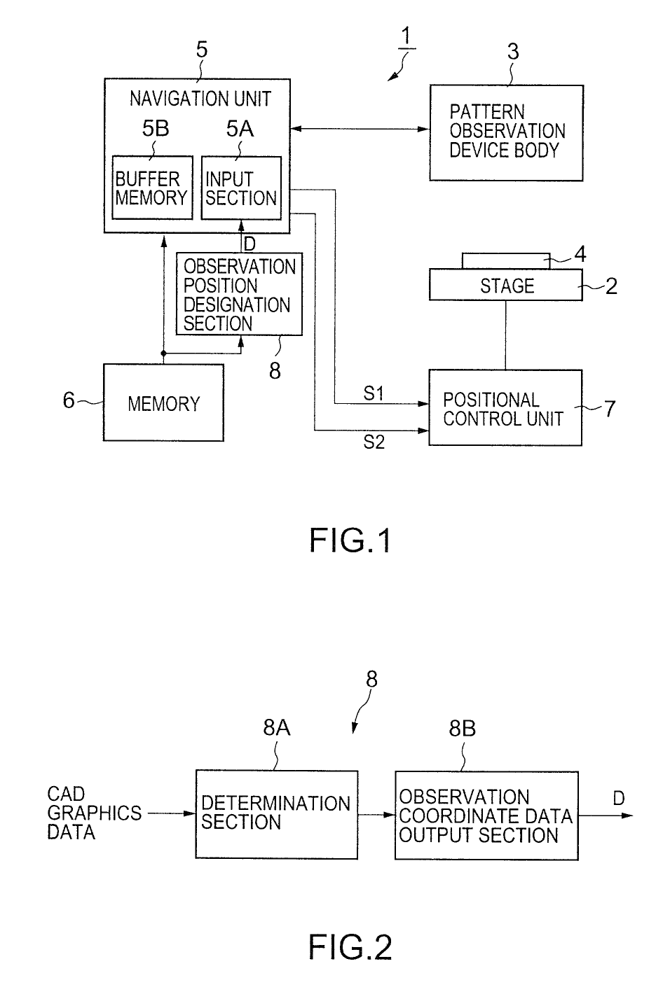

FIG. 1 is a system schematic diagram showing one example of an embodiment of a wafer pattern observation system of the present invention.

In a wafer pattern observation system 1, numeral 2 indicates a stage and numeral 3 indicates a pattern observation device body, and a navigation unit 5 is provided for enlarging specified locations of a pattern (not shown) formed on a wafer 4 set on the stage 2 at a high magnification factor for observation with the pattern observation body 3. CAD graphics data of a pattern formed on the wafer 4 is stored in an 4 externally provided memory 6.

The navigation unit 5 refers to necessary parts of the CAD graphics data in the memory 6, calculates offset amount data for correcting the relative position between the stage 2 and the pattern observation device body 3 by a stage error, and causes operation of a positional control unit 7 according to this offset amount data, so as to accurately position the pattern observation device body 3 at a specified place on the wafer 4.

The navigation system 5 is comprised of a specified navigation program installed in a well known computer device containing a microcomputer, and the navigation unit 5 operates in accordance with this navigation program. In this way, automatic positioning of the observational field of view of the pattern observation device body 3 required for enlargement of the pattern on the wafer 4 to a high magnification factor and observation is carried out with high accuracy.

Reference numeral 8 is an observation position designation section for determining a plurality of control points for a pattern (not shown) formed on the wafer 4 based on CAD graphics data stored in the memory 6, by performing analysis of the CAD graphics data, and providing a set of observation point coordinate data D in accordance with the determined plurality of control points to an input section 5A of the navigation unit 5 as data indicating a specified observation location, and the observation position designation section 8 makes it possible to automatically determine the plurality of control points for the pattern formed on the wafer 4.

The navigation unit 5 sequentially positions the observational field of view of the pattern observation device body 3 at the plurality of observation positions indicated by the observation coordinate data D, in accordance with the observation coordinate data D supplied to the input section 5A from the observation position designation section.

One example of the structure of the observation point designation section 8 is shown in FIG. 2. The observation location designation section 8 comprises a determination section 8A, for performing lithography simulation based on CAD graphics data read out from the memory 6, obtaining a pattern shape actually formed on the wafer 4 using simulation from an exposure or focus condition or light strength, performing superposition of the shape obtained by the simulation on a shape from CAD graphics data to obtain a difference between the two, and determining points that are to be controlled, in a pattern finalized from these results, at a plurality of locations, and an observation coordinate data output section 8B for obtaining a set of observation coordinate data required for observation of these control points based on the plurality of control points determined by the determination section 8A, and observation coordinate data D is output from the observation coordinate data output section 8B.

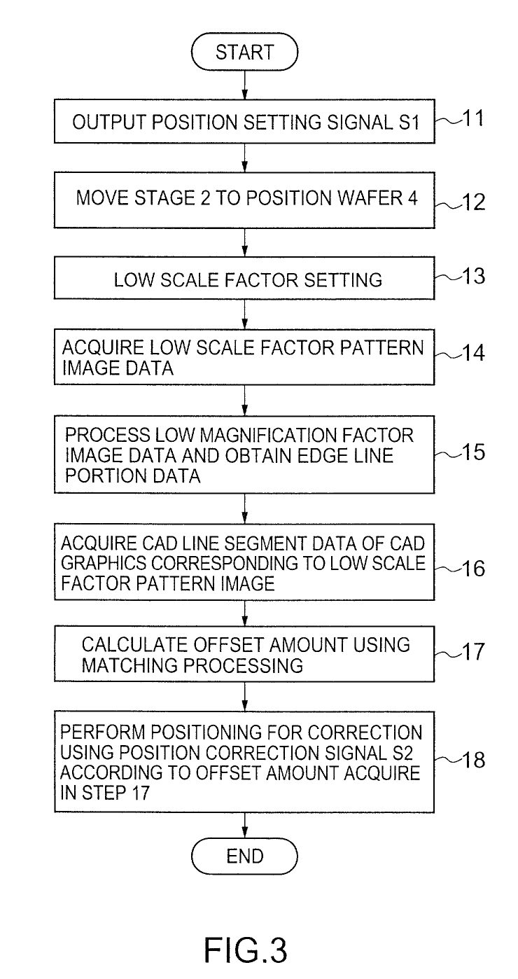

FIG. 3 is a flowchart of a navigation program installed in the navigation unit 5 for sequentially positioning the observational field of view of the pattern observation device body 3 according to observation coordinate data D acquired as described above, and the navigation operation performed by the navigation unit 5 will be described in the following with reference to FIG. 3.

In response to the observation coordinate data D, in step 11, first of all a position setting signal S1 representing a first observation position (control point) is output. In step 12, the position control unit 7 moves the stage 2 in response to the position setting signal S1, and in this way the wafer 4 is positioned with respect to the pattern observation device body 3 so that the center of the field of view of the pattern observation device body 3 coincides with the center of the field of view of the observation position designated at that time.

Next, in step 13, using a command from the navigation unit 5 an observation magnification factor for the pattern observation device body 3 is set to a low magnification factor suitable for placing the center of the observational field of view of the designated observation position in the observational field of view of the pattern observation device body 3. This low magnification factor can be established, for example, in consideration of the stage accuracy of the stage 2, at a magnification factor such that the center of the observational field of view of the designated observation position is placed in the observational field of view of the pattern observation device body 3 even if there is positional setting error foreseen in positioning the stage 2.

In step 14, using an instruction from the navigation unit 5, low magnification factor image data is acquired for the first observation position under the observation conditions described above, using the pattern observation device body 3, and the acquired low magnification factor pattern image data are stored in a buffer memory 5B inside the navigation unit 5.

In step 15, the low magnification factor pattern image data stored in the buffer memory 5B is processed by a known method, edge extraction of the image is performed, and in this way edge line segment data of the observed image are acquired based on the low magnification factor pattern image data.

In step 16, CAD graphics data corresponding to the acquired low magnification factor pattern image data are read out from the memory 6 and stored in the buffer memory 5B.This CAD graphics data constitutes data representing a CAD graphics with the center of observation of the pattern observation device body 3 as the center point, and CAD line segment data is acquired based on this read out CAD graphics data. This CAD line segment data is data representing line segments of the pattern according to the CAD graphics.

In step 17, a matching process for comparing the edge line segment data and the CAD line segment data is performed, and in this way an amount of offset between the observation center and the center of the observational field of view of the pattern observation device body 3 is computed. This offset amount is calculated as an amount of image shift in the observation plane.

In step 18, a position correction signal S2 is output in accordance with the offset amount acquired in step 17 to drive the stage 2 so that the observation center and the center of the observational field of view of the pattern observation device body 3 are aligned, and in this way the observation center and the center of the observational field of view of the pattern observation device body 3 are aligned.

By using the navigation unit 5 to first of all calculate an amount of offset between the center of observation of the low magnification factor pattern image and the center of the actual observational field of view of the pattern observation device body 3, make this offset amount a positioning error dependent on the stage precision and then move the stage 2 by this offset amount, in the above described manner, it is possible to accurately align the observational field of view of the pattern observation device body 3 with desired observation locations on the pattern of the wafer 4. Each of the operations involved in the above described alignment can also be performed by moving the pattern observation device body 3.

Accordingly, if accurate alignment is completed using the navigation unit 5 as described above, it is possible to directly acquire a high magnification factor image for the first observation location of the pattern of the wafer 4 by setting the magnification factor of the pattern observation device body 3 to a required high magnification factor.

By sequentially performing the above observation position alignment based on a second position and subsequent observation positions based on the observation coordinate data D, it is possible to automatically sequentially acquire observation images for all of the determined control points of the observation position designation unit 8. Because the wafer pattern observation system 1 is configured as described above, it is possible to acquire appropriate control points in a short time using the observation position designation unit 8, and it is also possible to automatically sequentially align the determined control points using the navigation unit 5 and to acquire an observation image using the pattern observation device body 3 for observation.

In the example shown in FIG. 2, lithography simulation has been be adopted as the technique for analysis of CAD data for determination of the control points, but other techniques can also be adopted. These other techniques will be exemplified in the following.

(1) Device Simulation

A device is made on a computer based on CAD graphics data, and a plurality of control points are determined from the view point of the electrical characteristics of the device.

(2) Process Simulation is carried out with gas diffusion time or gas amount for pattern formation as parameters, and problematic points of the formed pattern are ascertained to determine a plurality of control points.

(3) Etching Simulation A removal amount is simulated with exposure or etching fluid diffusion for pattern formation as parameters, and problematic points are ascertained from that standpoint to determine a plurality of control points.

(4) CAD pattern density The density of aggregates of pattern formation, portions at positions changing from high density to low density, problematic points in the case of pattern formation from an exposure image etc. are ascertained to determine a plurality of control points.

By analyzing the CAD graphics data from various standpoints in this way, it is possible to accurately ascertain appropriate control points for each situation and carry out determination in a short time. Since it is then possible to automatically observe each pattern for these control points using CAD navigation, it is possible to acquire observation images for a large amount of control points in an automatic operation. As a result this enables appropriate problem monitoring for various types of processes for wafer pattern manufacture, and improvements in manufacturing efficiency can be expected.

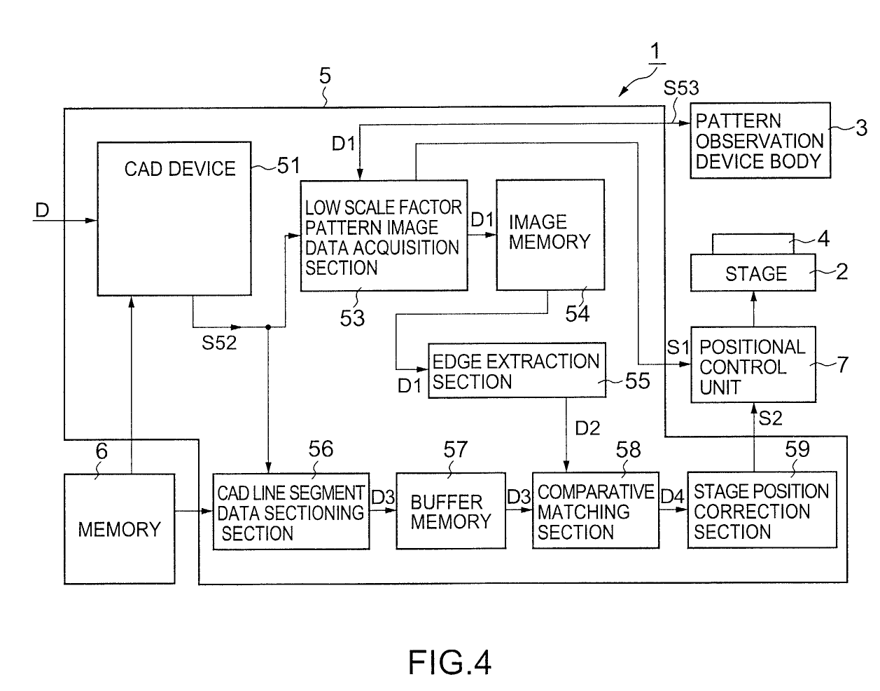

FIG. 4 is a schematic diagram for explaining one example of a device structure of the navigation unit 5 shown in FIG. 1. In FIG. 4, parts corresponding to parts in FIG. 1 have the same reference numerals, and explanation of those parts is omitted.

In describing the device structure of the navigation unit 5, 51 is a CAD device, and observation coordinate data D from the observation position designation section 8 is input to the CAD device 51. Numeral 53 is a low magnification factor pattern image data acquisition section, and if observation locations are designated using the observation coordinate data D,

a position setting signal S1 corresponding to a designation signal S52 output is output from the low magnification factor pattern image data acquisition section 53, and positioning of the stage 2 described in step 12 of FIG. 3 is executed. On the other hand, the pattern observation body 3 is set to a low magnification factor in response to a low magnification factor setting signal S53, as described in step 13, and low magnification factor pattern image data D1 acquired by the pattern observation device body 3 are sent to a low magnification factor pattern image data acquisition section 53 and stored in an image memory 54. Edge extraction processing is then carried out in the edge extraction section 55 based on low magnification factor pattern image data stored in the image memory 54, as described in step 15 of FIG. 3, and edge line segment data D2 is output.

On the other hand, in the CAD line segment data sectioning section 56, CAD line segment data D3 corresponding to designated observation location is read out from the memory 6 in response to a designation signal S52, and stored in the buffer memory 57.

In the comparative matching section 58, edge line segment data D2 from the edge extraction section 55 is compared with the CAD line segment data D3 from the buffer memory 57, and matching processing is executed to calculate an offset amount. The calculation processing here corresponds to the processing described in step 17 in FIG. 3. Offset amount data D4 representing an offset amount acquired by the comparative matching section 58 is sent to the stage position correction section 59, a position correction signal S2 is generated for moving the stage 2 so that the center of observation of the low magnification factor pattern image and the center of the actual observational field of view of the pattern observation device body 3, and this position correction signal S2 is sent to the position correction unit 7.

According to the present invention, by analyzing the CAD graphics data from various standpoints, it is possible to accurately ascertain appropriate control points for each situation and carry out determination in a short time. Since it is then possible to automatically observe each pattern for these control points using CAD navigation, it is possible to acquire observation images for a large amount of control points in an automatic operation. As a result this enables appropriate problem monitoring for various types of process for wafer pattern manufacture, and improvements in manufacturing efficiency can be expected.

What is claimed is:

1. A wafer observation method for enlarging and observing, with a pattern observation device, a plurality of wafer pattern control points formed on a wafer based on CAD data, wherein
the plurality of control points are determined by analysis of the CAD data, a set of observation coordination data are acquired in accordance with the determined plurality of control points, the CAD data are referenced Lo carry out positional navigation in accordance with the set of observation coordinate data, and the determined plurality of control points of the wafer pattern are sequentially observed.

2. The wafer observation method of claim 1, wherein determination of the plurality of control points is carried out using lithography simulation, device simulation, process simulation, etching simulation, or a CAD pattern density analysis method.

3. The wafer observation method of claim 1, wherein the positional navigation method is realized as a CAD navigation method that performs observational positioning of the pattern observation device to a low magnification factor so that observation centers of the control points are placed in an observation field of view to acquire wafer pattern low magnification factor pattern image data, calculates an offset amount between the observation centers and centers of the observation field of view from the low magnification factor pattern image data and CAD graphics data corresponding to the low magnification factor pattern image data, and performs relative positional control of the wafer based on this offset amount data so that the centers of observation are aligned with the centers of the observation field of view.

4. A wafer pattern observation device for enlarging and observing, with a pattern observation device, a plurality of wafer pattern control points formed oil a wafer based on CAD, comprising:
a pattern observation device body;
determination means for analyzing the CAD data and determining a plurality of control points;
means for acquiring a set of observational coordinate data based in the plurality of control points determine by the determination means; and
a CAD navigation device for sequentially and automatically performing observational positioning for the pattern observation using the pattern observation device body according to the set of observational coordinate data arid the CAD data.
